(19) United States
(12) Patent Application Publication
(10) Pub. No.: US 2017/0070481 A1
(43) Pub. Date: Mar. 9, 2017

(54) COMMUNICATION CHANNEL SECURITY AGAINST PACKET SNIFFING

(71) Applicant: PILIXO LIMITED, Dublin (IE)

(72) Inventor: Eugene Manko, Three Kings (NZ)

(21) Appl. No.: 14/844,586

(22) Filed: Sep. 3, 2015

(51) Int. Cl. H04L 29/06

(52) U.S. Cl. CPC H04L 63/0428; H04L 63/0478

(57) ABSTRACT

Data security can be optimized by applying secret obfuscation keys which are known, changed and updated among transmitting and receiving devices. One example of operation may include identifying data to be transmitted to a recipient device, receiving a current security pre-condition to use when creating a message to send the data, obfuscating the data based on the current security pre-condition and creating the message to include the obfuscated data, and transmitting the message to the recipient device.

### TECHNICAL FIELD OF THE APPLICATION

This application relates to securing a communication channel and more particularly to preparing parties to a communication to establish a security measure prior to transmitting data between the parties.

### BACKGROUND OF THE APPLICATION

Conventionally, communication among users on a network involves security measures, such as encryption. The encryption technique selected although difficult to crack or uncover may be regarded as predictable by security threats imposed by third parties. More than often it is desirable to highly obfuscate data on a communication channel to prevent eavesdroppers from intercepting information in clear text or other obvious data formats. However, existing obfuscating solutions use predictable patterns over and over again, that once learned can easily be circumvented in the future. Clearly, there are solutions that address this type of security threat, such as using key exchanges using various sharing techniques and fully encrypting channel traffic. Additionally, encryption solutions can require large processing times and involve a significant number of round trips to exchange keys and establish a trust relationship.

### SUMMARY OF THE APPLICATION

One example embodiment may provide a method that includes at least one of identifying data to be transmitted to a recipient device, receiving a current security pre-condition to use when creating a message to send the data, obfuscating the data based on the current security pre-condition and creating the message to include the obfuscated data, and transmitting the message to the recipient device.

Another example embodiment may include an apparatus including at least one of a processor configured to identify data to be transmitted to a recipient device, a receiver configured to receive a current security pre-condition to use when a message is being created to send the data, and the processor is further configured to obfuscate the data based on the current security pre-condition, wherein the message is created to include the obfuscated data, and a transmitter configured to transmit the message to the recipient device.

Another example embodiment may include a non-transitory computer readable storage medium configured to store instructions that when executed causes a processor to perform at least one of identifying data to be transmitted to a recipient device, receiving a current security pre-condition to use when creating a message to send the data, obfuscating the data based on the current security pre-condition and creating the message to include the obfuscated data, and transmitting the message to the recipient device.

### BRIEF DESCRIPTION OF THE DRAWINGS

FIG. 1 illustrates an example prior art communication network security configuration.

FIG. 2 illustrates an example communication network security configuration according to example embodiments of the present application.

FIG. 3 illustrates a system signaling diagram of a communication pattern among communication devices according to example embodiments.

FIG. 4 illustrates an example data security logic diagram according to example embodiments of the present application.

FIG. 5 illustrates an example data logic security platform according to the present application.

FIG. 6 illustrates an example network entity device configured to store instructions, software, and corresponding hardware for executing the same, according to example embodiments of the present application.

### DETAILED DESCRIPTION OF THE APPLICATION

It will be readily understood that the components of the present application, as generally described and illustrated in the figures herein, may be arranged and designed in a wide variety of different configurations. Thus, the following detailed description of the embodiments of a method, apparatus, and system, as represented in the attached figures, is not intended to limit the scope of the application as claimed, but is merely representative of selected embodiments of the application.

The features, structures, or characteristics of the application described throughout this specification may be combined in any suitable manner in one or more embodiments. For example, the usage of the phrases “example embodiments”, “some embodiments”, or other similar language, throughout this specification refers to the fact that a particular feature, structure, or characteristic described in connection with the embodiment may be included in at least one embodiment of the present application. Thus, appearances of the phrases “example embodiments”, “in some embodiments”, “in other embodiments”, or other similar language, throughout this specification do not necessarily all refer to the same group of embodiments, and the described features, structures, or characteristics may be combined in any suitable manner in one or more embodiments.

In addition, while the term “message” has been used in the description of embodiments of the present application, the application may be applied to many types of network data, such as, packet, frame, datagram, etc. For purposes of this application, the term “message” also includes packet, frame, datagram, and any equivalents thereof. Furthermore, while certain types of messages and signaling are depicted in exemplary embodiments of the application, the application is not limited to a certain type of message, and the application is not limited to a certain type of signaling.

According to example embodiments, generating obfuscation keys with each message may offer dynamic security measures on a communication network provided both communication end devices are aware of the algorithm that generated the key and the obfuscation algorithm used. Then the procedure of obfuscation/de-obfuscation of messages may be performed with almost no additional processing time, yet highly randomized keys may be used to create messages that provide no indication as to the key used or the key length based on the original message size.

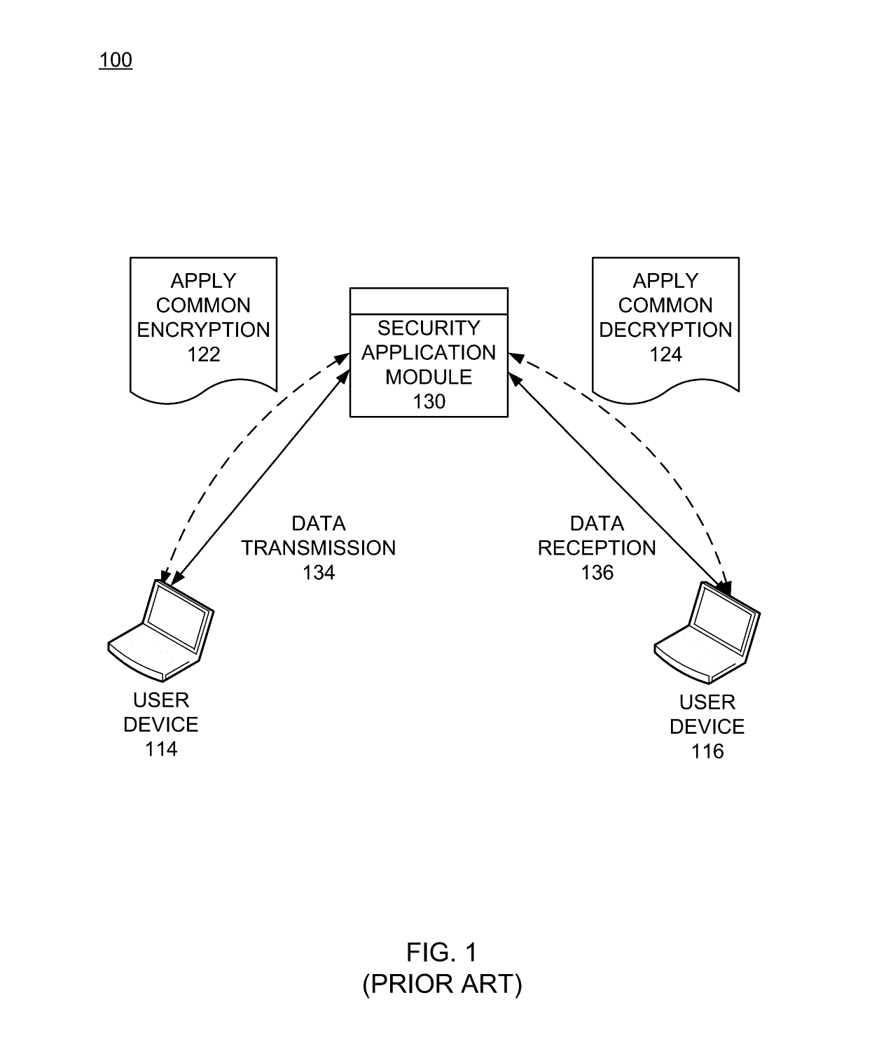

FIG. 1 illustrates a conventional prior art communication network 100. Referring to FIG. 1, the security application module 130 may serve as a plug-in, agent and/or mediator between two or more communication devices seeking to establish communication across the network. For instance, if user device 114 is a transmitting device and is attempting to transmit a secure message 134 to user device 116, the data transmission may apply a common encryption method 122 to the data prior to generating the message packets and transmitting the data to the user device 116. The encryption may be decrypted via a shared decryption key 124. This approach is static and offers no security to third parties that have first-hand knowledge of the types of encryption, keys used, where the keys are stored and how to access such data during a data reception 136.

Example embodiments operate in a peer-to-peer (P2P) configuration without requiring any server between. A precondition is known by both ends of the communication link upfront. For instance, if the message length is over 60 bytes then the key size may be 6 bytes or if the message length is over 80 bytes then the key size may be 8 bytes and the key will be split in two halves one located in the beginning and the other one at an offset byte, such as byte 40 of the message. Since both sides “know” all potential pre-conditions upfront no additional communication is required to exchange them and to possibly leak them to third parties. It is possible to learn all possible preconditions but since data appears random it might take just as long as cracking an encryption algorithm.

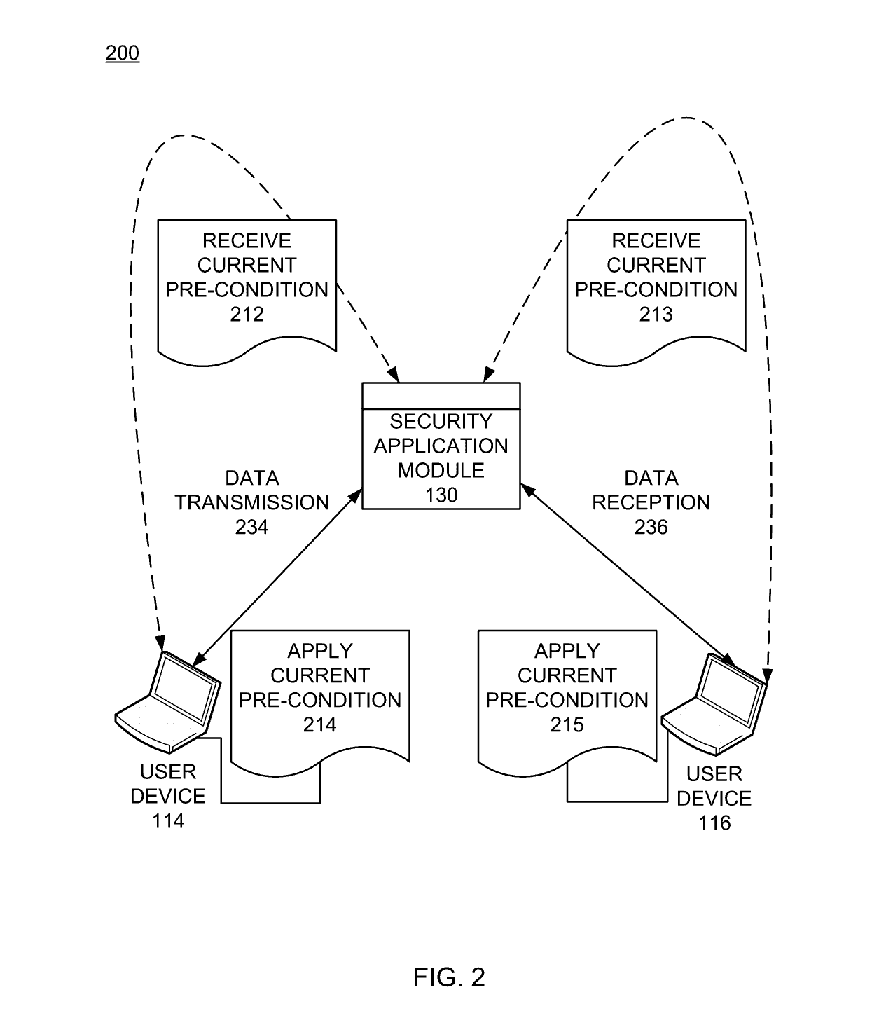

FIG. 2 illustrates a communication network according to example embodiments of the present application. Referring to FIG. 2, the network 200 includes a transmitting device 114, a receiving device 116 and a mediator module 130. However, before a message is processed, packaged and transmitted from one device to another device, the current pre-condition is identified and applied during the message processing procedure to use an updated dynamic form of encryption prior to transmitting the message across the network. In operation, both ends of a channel must know the basics of the algorithm currently being used. In this approach, there is no explicit “agreement” or “algorithm negotiation” required but rather a pre-condition that both ends of the communication channel can apply to the message processing procedure. For example, one rule may be applied when the overall message received size is over 60 bytes then a key that is 6 bytes long can be used and which locations in the data stream to apply the key.

The user device 114 may identify data that is to be transmitted to the user device 116. The current pre-condition 214 may be retrieved and applied from the security module 130 or from the recipient device 116 depending on how the updates are shared. The data transmission 234 can then be sent based on the current pre-condition 212. The receiving device can also receive the pre-condition 213 along with the data 236 so the pre-condition can be applied 215 to decode the data into an intelligible format.

The security module 130 may provide a library that serves both ends of the communication channel. The devices may be “compatible” so they process identical code (e.g. library code that serves both ends of the pipe). Both ends of the communication channel are notified how to process the data when the total message is 60 bytes or more (e.g., above a data threshold size) or when message size is 45 bytes or less (below a data threshold size) or when the message size is between 45 bytes and 60 bytes (e.g., between two data threshold sizes), and what key size is appropriate for this particular data message length.

According to one example, a data message arrives as 67 bytes long. The receiving end is aware that for messages longer than 60 bytes the key will be 6 bytes with 3 of the bytes located in front and 3 bytes located in the back of the message. As a result, the device extracts the first 3 bytes of the key and shifts the message block 3 bytes to the left to fill the gap and then extracts the last 3 bytes from the end and fills that gap by simply nullifying the last 3 bytes in the message. The resulting key is 6 bytes and the resulting message is 61 bytes. The next operation includes performing an XOR operation for every byte of the message with every byte of the key and the result will be the clear text of the message. Simply observing the message does not provide details as to where the parts of the key are located or whether the message length is encrypted as part of the message or not as in the case of block ciphers that only operate on a block of a fixed size, the message appears totally random. Each message receives a new key so even if one message is cracked the same approach will not crack other messages as every message or few messages are using a different key.

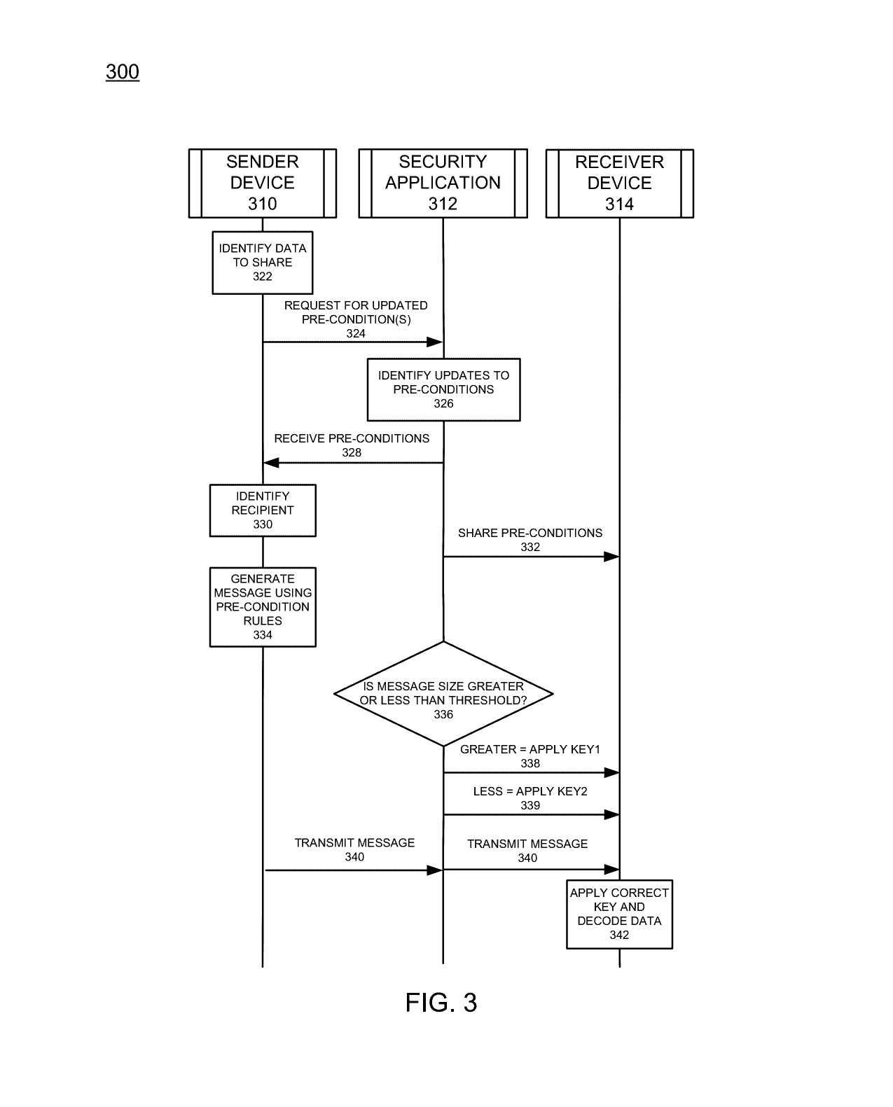

FIG. 3 illustrates a communication signaling system diagram of a communication example between network devices according to example embodiments. Referring to FIG. 3, the example communication diagram 300 includes three main devices including the sender device 310, the receiver device 314 and the security application 312. In operation, the sender device 310 may identify certain data 322 to share with the receiver device 314. The security application 312 may request for updated pre-conditions 324 prior to constructing any message format, packet or other datagram. The security application 312 may be responsible for identifying the recent pre-conditions 326 to apply to the message sharing operations. The pre-conditions may be created periodically and updated after a certain window of time has elapsed, after a recent message transfer operation, responsive to a message request, etc. In this configuration, there is no need for a security server or third party device operating to share encryption and maintain keys.

The pre-conditions must be shared 328 with the sender device 310 and shared 332 the receiver device 314 prior to sharing data from one device to another. Once the recipient is identified 330, the pre-conditions can be transferred to that device assuming the recipient device does not already have those updated pre-conditions. Next, a message may be generated and shared using the pre-condition rules 334. The message may be obfuscated according to the rules received. Certain rules can be applied to assist with the obfuscation procedure including determining the message size and comparing the size to a predetermined threshold size 336. If the message size is greater than the threshold size then a certain key1 will be applied 338, if the message is less than the threshold size then another key (key2) will be applied 339 to obfuscate the message. The message will be transmitted 340 to the receiver device 314 and the correct key can be applied to decode the data 342.

Obfuscation is generally referred to as a form of encryption (i.e., simple bit changes and bit replacement methods “XOR” operations, etc.). The device that is transmitting a message generates a random key of a pre-agreed length, which could be a constant length type key included in the data itself, or a length based on the software version currently being used, and/or a length based on the message length among other options for establishing the length. The current pre-condition length must be shared with each end of the communication channel so both devices or all devices have knowledge of the key length based on any of the above mentioned pre-determined length conditions.

The message can then be obfuscated using any pre-agreed algorithm or pre-condition. For example, if the message length is smaller than 60 bytes then XOR may be used and with a key length of 4 bytes. If the message length is greater than 60 bytes then a data encryption algorithm (DES) may be used instead of XOR and the key length will now be 8 bytes. For simplicity, an XOR operation may be performed for every character of the message with every character of the key. However, every character of the key may be inserted at predefined positions within the message itself and this will be the final message to be transmitted. Pre-defined positions in the resulting message will have bytes inserted. For instance, a 4 byte key can be applied as the first 4 bytes of the message or the last 4 bytes of the message, or 2 bytes can be inserted at the beginning of the message and 2 bytes at the end of the data. For keys that are 8 bytes long those keys may be inserted at other portions of the data but both communication ends must have knowledge of where to locate the keys as part of the pre-condition information. This is ensured by the library code that is shared with the various network devices. To an eavesdropper third party device, the message contents will appear to be completely random with no message length or key being transmitted or original message length at any known location since the obfuscation strategy is a secret, is dynamic and is updated periodically to deter third parties from obtaining data access.

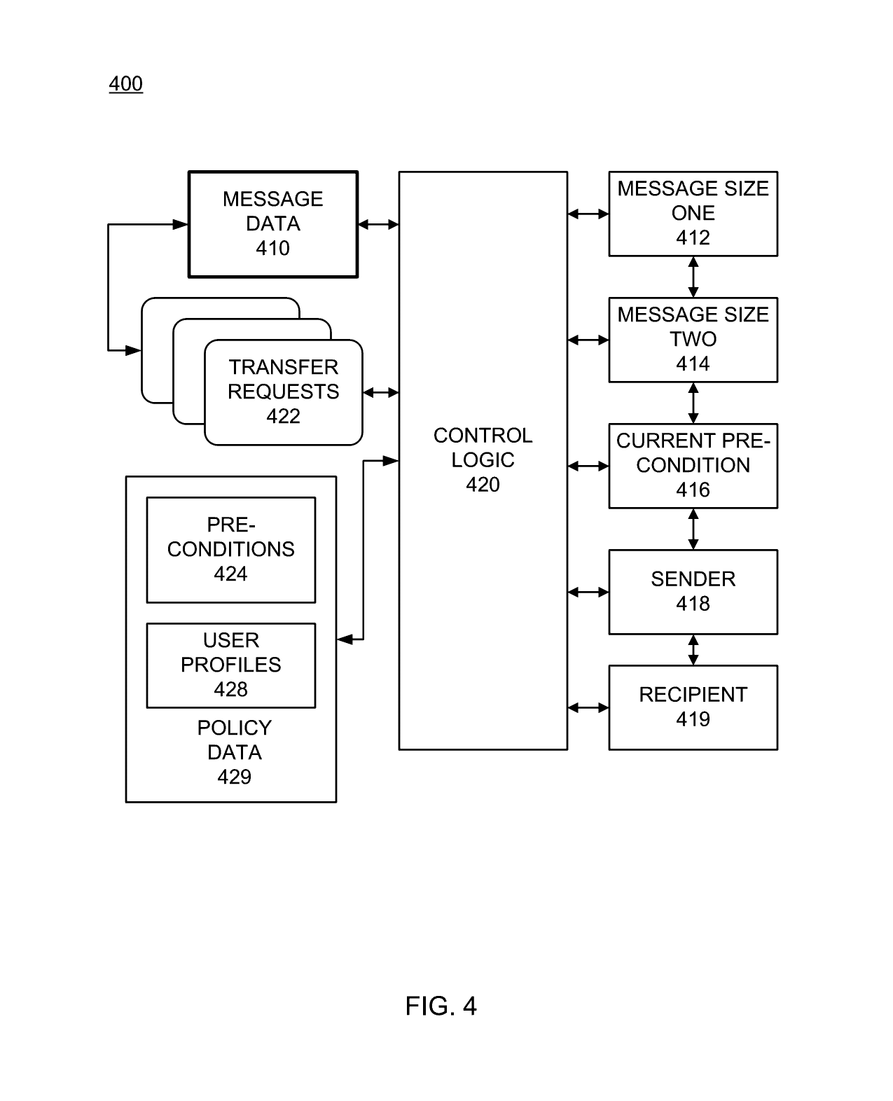

FIG. 4 illustrates an example logic diagram according to example embodiments. Referring to FIG. 4, the logic 400 includes a control logic or processor 420 which is responsible for processing various inputs and outputs. For example, the message data 410 may be received and may be subject to transformation via the obfuscation pre-conditions currently being shared among the network devices. The transfer requests 422 identified by the logic 420 may include identifying the message data 410 to be obfuscated, applying pre-conditions 424, identifying the user profiles 428 linked to the user devices and the corresponding policy data 429 for communicating data. The other parameters processed by the control logic 420 may include identifying whether the message size is a first size 412, a second size 414, what pre-conditions are available to apply 416, who the sender device is identified to be 418, and who the recipient device is identified to be 419.

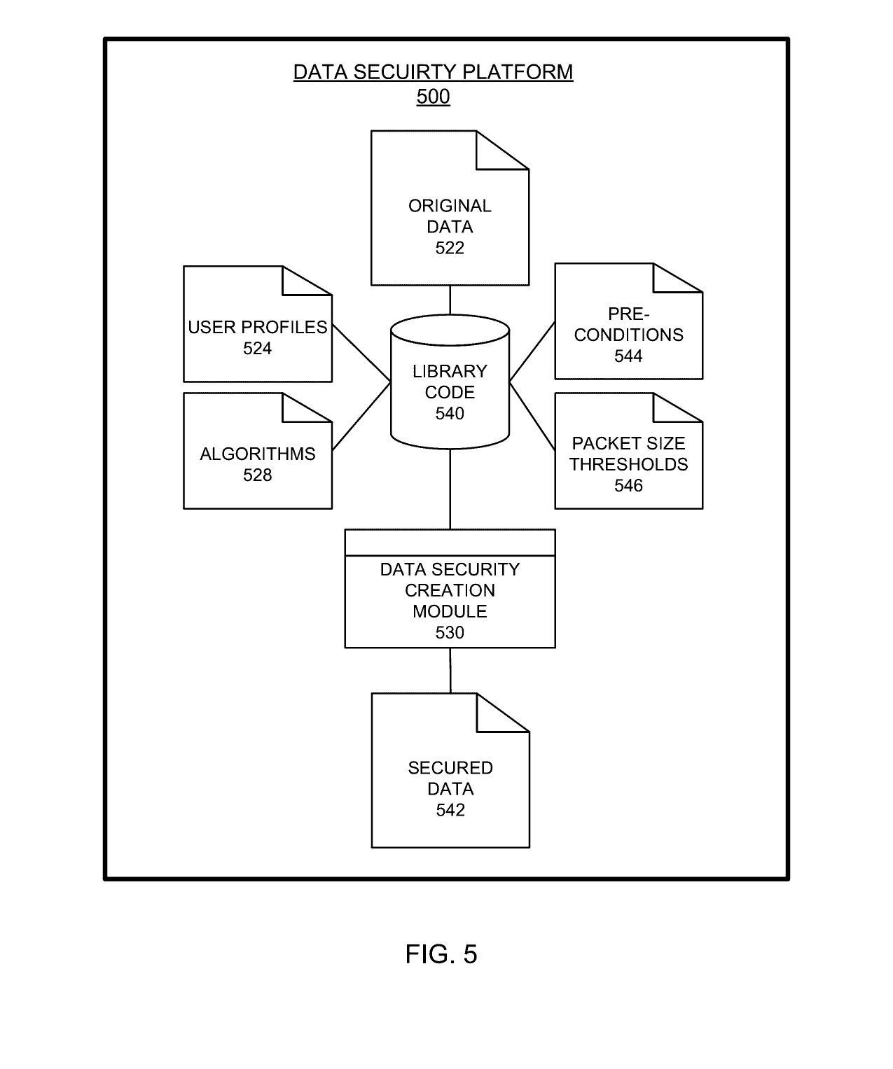

FIG. 5 illustrates a data security platform 500 with a set of varying data parameters being shared among the data network devices. Referring to FIG. 5, the library code 540 may represent the code that is shared with all devices communicating on the network. For example, the original data to be obfuscated 522 will be setup and processed based on the library code received including pre-conditions 544, packet size thresholds 546, algorithms 528 and user profile information 524. The data security creation module 530 may be an agent or computer program that operates to perform the obfuscation procedure on the original data 522 to create the obfuscated secured data 542 that is ready for transmission.

For every message received, based on the pre-agreed algorithm and current pre-conditions, every key byte is extracted from the message. Every character of the message is shifted to the left to close the gaps occupied by the bytes of the key. Using the pre-agreed algorithm, a plain text message is reconstructed from the obfuscated data. As in the data “send” example, using a simple XOR operation, the procedure will take every character of the message, XOR those characters with every character of the key and obtain the original message.

The key may represent a randomly generated number of bytes of a pre-agreed length based on any pre-agreed condition. For example, a rule may provide if the message length (Lm) is >=30 characters then use a key length of 6 bytes, if message length (Lm) is >=60 characters then use key length of 12 bytes. As for the obfuscation algorithm, the strategy may include any suitable algorithm that can apply to the message a random key to every character of the message (i.e., XOR is the simplest example of such an algorithm). Obfuscation and encryption are often viewed as being the same. Generally speaking obfuscation attempts to modify incoming information such that it will appear random to the observer. Encryption is the same but it is using algorithms that are considered by the cryptography community as “strong” so only a brute-force attack can crack the code or a key can be stolen but the key itself cannot be recovered or derived from the encrypted message. Obfuscation generally does not provide “strong” encryption, but instead makes claims to provide enough randomness so that message cannot be easily eavesdropped if at all.

The operations of a method or algorithm described in connection with the embodiments disclosed herein may be embodied directly in hardware, in a computer program executed by a processor, or in a combination of the two. A computer program may be embodied on a computer readable medium, such as a storage medium. For example, a computer program may reside in random access memory (“RAM”), flash memory, read-only memory (“ROM”), erasable programmable read-only memory (“EPROM”), electrically erasable programmable read-only memory (“EEPROM”), registers, hard disk, a removable disk, a compact disk read-only memory (“CD-ROM”), or any other form of storage medium known in the art.

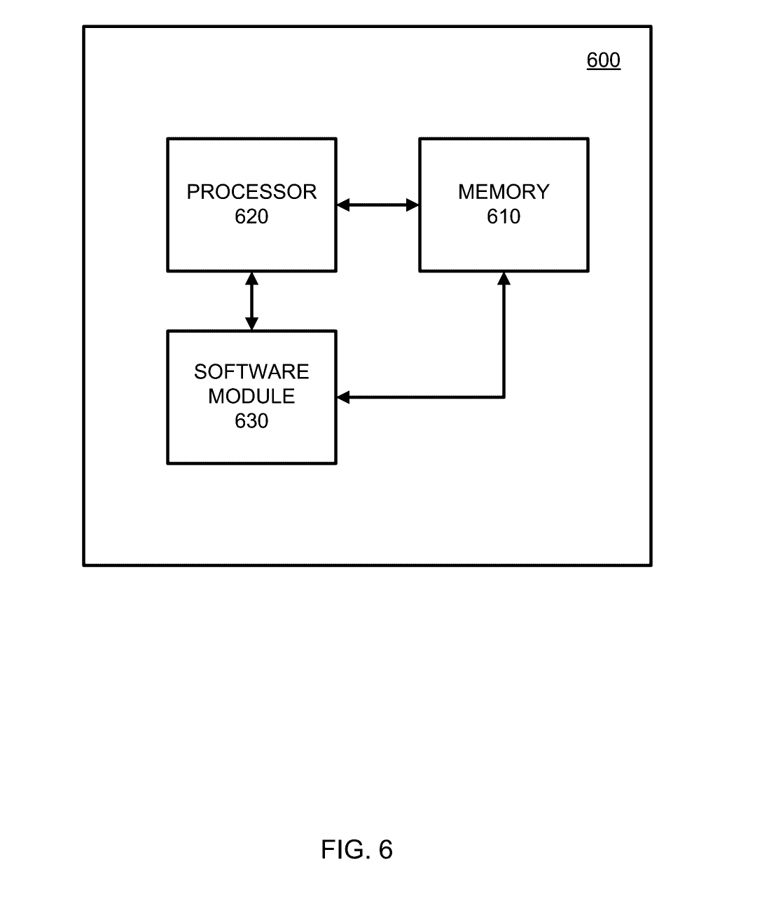

An exemplary storage medium may be coupled to the processor such that the processor may read information from, and write information to, the storage medium. In the alternative, the storage medium may be integral to the processor. The processor and the storage medium may reside in an application specific integrated circuit (“ASIC”). In the alternative, the processor and the storage medium may reside as discrete components. For example, FIG. 6 illustrates an example network element 600, which may represent any of the above-described network components, etc.

As illustrated in FIG. 6, a memory 610 and a processor 620 may be discrete components of the network entity 600 that are used to execute an application or set of operations. The application may be coded in software in a computer language understood by the processor 620, and stored in a computer readable medium, such as, the memory 610. The computer readable medium may be a non-transitory computer readable medium that includes tangible hardware components in addition to software stored in memory. Furthermore, a software module 630 may be another discrete entity that is part of the network entity 600, and which contains software instructions that may be executed by the processor 620. In addition to the above noted components of the network entity 600, the network entity 600 may also have a transmitter and receiver pair configured to receive and transmit communication signals (not shown).

Although an exemplary embodiment of the system, method, and computer readable medium of the present application has been illustrated in the accompanied drawings and described in the foregoing detailed description, it will be understood that the application is not limited to the embodiments disclosed, but is capable of numerous rearrangements, modifications, and substitutions without departing from the spirit or scope of the application as set forth and defined by the following claims. For example, the capabilities of the system of the various figures can be performed by one or more of the modules or components described herein or in a distributed architecture and may include a transmitter, receiver or pair of both. For example, all or part of the functionality performed by the individual modules, may be performed by one or more of these modules. Further, the functionality described herein may be performed at various times and in relation to various events, internal or external to the modules or components. Also, the information sent between various modules can be sent between the modules via at least one of: a data network, the Internet, a voice network, an Internet Protocol network, a wireless device, a wired device and/or via plurality of protocols. Also, the messages sent or received by any of the modules may be sent or received directly and/or via one or more of the other modules.

One skilled in the art will appreciate that a “system” could be embodied as a personal computer, a server, a console, a personal digital assistant (PDA), a cell phone, a tablet computing device, a smartphone or any other suitable computing device, or combination of devices. Presenting the above-described functions as being performed by a “system” is not intended to limit the scope of the present application in any way, but is intended to provide one example of many embodiments of the present application. Indeed, methods, systems and apparatuses disclosed herein may be implemented in localized and distributed forms consistent with computing technology.

It should be noted that some of the system features described in this specification have been presented as modules, in order to more particularly emphasize their implementation independence. For example, a module may be implemented as a hardware circuit comprising custom very large scale integration (VLSI) circuits or gate arrays, off-the-shelf semiconductors such as logic chips, transistors, or other discrete components. A module may also be implemented in programmable hardware devices such as field programmable gate arrays, programmable array logic, programmable logic devices, graphics processing units, or the like.

A module may also be at least partially implemented in software for execution by various types of processors. An identified unit of executable code may, for instance, comprise one or more physical or logical blocks of computer instructions that may, for instance, be organized as an object, procedure, or function. Nevertheless, the executables of an identified module need not be physically located together, but may comprise disparate instructions stored in different locations which, when joined logically together, comprise the module and achieve the stated purpose for the module. Further, modules may be stored on a computer-readable medium, which may be, for instance, a hard disk drive, flash device, random access memory (RAM), tape, or any other such medium used to store data.

Indeed, a module of executable code could be a single instruction, or many instructions, and may even be distributed over several different code segments, among different programs, and across several memory devices. Similarly, operational data may be identified and illustrated herein within modules, and may be embodied in any suitable form and organized within any suitable type of data structure. The operational data may be collected as a single data set, or may be distributed over different locations including over different storage devices, and may exist, at least partially, merely as electronic signals on a system or network.

It will be readily understood that the components of the application, as generally described and illustrated in the figures herein, may be arranged and designed in a wide variety of different configurations. Thus, the detailed description of the embodiments is not intended to limit the scope of the application as claimed, but is merely representative of selected embodiments of the application.

One having ordinary skill in the art will readily understand that the application as discussed above may be practiced with steps in a different order, and/or with hardware elements in configurations that are different than those which are disclosed. Therefore, although the application has been described based upon these preferred embodiments, it would be apparent to those of skill in the art that certain modifications, variations, and alternative constructions would be apparent, while remaining within the spirit and scope of the application. In order to determine the metes and bounds of the application, therefore, reference should be made to the appended claims.

While preferred embodiments of the present application have been described, it is to be understood that the embodiments described are illustrative only and the scope of the application is to be defined solely by the appended claims when considered with a full range of equivalents and modifications (e.g., protocols, hardware devices, software platforms etc.) thereto.

What is claimed is:

1. A method comprising:
identifying data to be transmitted to a recipient device;
receiving a current security pre-condition to use when creating a message to send the data;
obfuscating the data based on the current security pre-condition and creating the message to include the obfuscated data; and
transmitting the message to the recipient device.

2. The method of claim 1, wherein the current security pre-condition comprises an obfuscation key that is different from a previously used security pre-condition and previously used obfuscation key.

3. The method of claim 1, further comprising:
sharing a library comprising the current security pre-condition with a transmitting device and the recipient device prior to obfuscating the data.

4. The method of claim 1, wherein the transmitting device and the recipient device each receive the current security pre-condition prior to the transmitting device creating the message.

5. The method of claim 1, further comprising:
identifying a size of the data and determining whether the size of the data is greater than or less than a threshold data size.

6. The method of claim 5, further comprising:
when the size of the data is determined to be greater than the threshold data size, applying a first obfuscation key to the data comprising a first number of key bytes.

7. The method of claim 6, further comprising:
when the size of the data is determined to be less than the threshold data size, applying a second obfuscation key to the data comprising a second number of key bytes, wherein the second number of key bytes are fewer than the first number of key bytes.

8. An apparatus comprising:
a processor configured to identify data to be transmitted to a recipient device;
a receiver configured to receive a current security pre-condition to use when a message is being created to send the data, and
wherein the processor is further configured to obfuscate the data based on the current security pre-condition, wherein the message is created to include the obfuscated data; and
a transmitter configured to transmit the message to the recipient device.

9. The apparatus of claim 8, wherein the current security pre-condition comprises an obfuscation key that is different from a previously used security pre-condition and previously used obfuscation key.

10. The apparatus of claim 8, wherein the processor is further configured to share a library comprising the current security pre-condition with the recipient device prior to the data being obfuscated.

11. The apparatus of claim 8, wherein the apparatus and the recipient device each receive the current security pre-condition prior to the message being created.

12. The apparatus of claim 8, wherein the processor is further configured to identify a size of the data and determine whether the size of the data is greater than or less than a threshold data size.

13. The apparatus of claim 12, wherein when the size of the data is determined to be greater than the threshold data size, the processor applies a first obfuscation key to the data comprising a first number of key bytes.

14. The apparatus of claim 13, wherein when the size of the data is determined to be less than the threshold data size, the processor applies a second obfuscation key to the data comprising a second number of key bytes, wherein the second number of key bytes are fewer than the first number of key bytes.

15. A non-transitory computer readable storage medium configured to store instructions that when executed causes a processor to perform:
identifying data to be transmitted to a recipient device;
receiving a current security pre-condition to use when creating a message to send the data;
obfuscating the data based on the current security pre-condition and creating the message to include the obfuscated data; and
transmitting the message to the recipient device.

16. The non-transitory computer readable storage medium of claim 15, wherein the current security pre-condition comprises an obfuscation key that is different from a previously used security pre-condition and previously used obfuscation key.

17. The non-transitory computer readable storage medium of claim 15, wherein the processor is further configured to perform:
sharing a library comprising the current security pre-condition with a transmitting device and the recipient device prior to obfuscating the data.

18. The non-transitory computer readable storage medium of claim 15, wherein the transmitting device and the recipient device each receive the current security pre-condition prior to the transmitting device creating the message.

19. The non-transitory computer readable storage medium of claim 15, wherein the processor is further configured to perform:
identifying a size of the data and determining whether the size of the data is greater than or less than a threshold data size.

20. The non-transitory computer readable storage medium of claim 19, wherein the processor is further configured to perform:
when the size of the data is determined to be greater than the threshold data size, applying a first obfuscation key to the data comprising a first number of key bytes.
